(19) United States
(12) Patent Application Publication
(10) Pub. No.: US 2022/0388410 A1
(43) Pub. Date: Dec. 8, 2022

(54) Pedestal Device

(71) Applicant: INCHARGE ENERGY INC, Santa Monica, CA (US)

(72) Inventor: Cameron Funk, Santa Monica, CA (US)

(73) Assignee: INCHARGE ENERGY INC, Santa Monica, CA (US)

(21) Appl. No.: 17/830,188

(22) Filed: Jun. 1, 2022

Related U.S. Application Data
(60) Provisional application No. 63/196,221, filed on Jun. 2, 2021.

(51) Int. Cl. B60L 53/31; B60L 3/04; B60L 53/30

(52) U.S. Cl. CPC B60L 53/31; B60L 3/04; B60L 53/305; B60L 53/18

(57) ABSTRACT

The present disclosure provides pedestal devices that function as an integrated solution for rapidly creating commercial scale vehicle charging stations. These pedestal devices provide a simple plug and play format which allows for rapid installation on the go.

### CROSS REFERENCE TO RELATED APPLICATIONS

The present disclosure claims the benefit of U.S. Provisional Patent Application 63/196,221 filed on Jun. 2, 2021.

### TECHNICAL FIELD

The present disclosure relates generally to vehicle charging stations and more specifically to pedestal devices for electric vehicle charging stations.

### BACKGROUND OF THE DISCLOSURE

The following discussion of related art is provided to assist the reader in understanding the advantages of the invention and is not to be construed as an admission that this related art is prior art to this invention.

Electric vehicles are typically charged at charging stations. Conventional depot boxes and wall boxes sold by electric vehicle supply equipment (EVSE) manufacturers today require auxiliary forms of mounting, multiple communication AC/DC power inputs, and do not include cable management or indicator lights. This makes it difficult to rapidly set up charging stations for fleets. Conventional depot boxes and wall boxes also do not have any convenience lighting for the users during night-time to use the charger. Cables are often tangled and left on the ground.

There exists a need in the art to address the problems described above. Specifically, what is needed is a solution that offers an easy user experience for installation of EVSE at fleet charging sites.

### SUMMARY OF THE DISCLOSURE

Embodiments of the present disclosure relate to systems and methods for pedestal devices to charge an electric vehicle. Each of the embodiments disclosed herein may include one or more of the features described in connection with any of the other disclosed embodiments.

In one embodiment, a pedestal device or multiple pedestal devices are provided that function as an integrated solution for rapidly installing commercial scale vehicle charging stations. These pedestal devices provide a simple plug and play format which allows for rapid installation and easy maintenance.

It can be appreciated that this plug and play format makes it easy to quickly set up a charging station for electrified fleets. The simplicity can also provide compliance with the Americans with Disabilities Act (ADA). This solution results in significantly less installation labor while adding significant features mentioned above.

Although specific advantages have been enumerated above, various embodiments may include some, none, or all of the enumerated advantages. Additionally, other technical advantages may become readily apparent to one of ordinary skill in the art after review of the following figures and description.

### BRIEF DESCRIPTION OF THE DRAWINGS

For a more complete understanding of the present disclosure and its advantages, reference is now made to the following description taken in conjunction with the accompanying drawings, in which like reference numerals represent like parts. The accompanying drawings, which are incorporated in and constitute a part of this specification, illustrate exemplary embodiments of the present disclosure and together with the description, explain the principles of the disclosure.

FIG. 1 illustrates a front view of a depot box pedestal according to an embodiment of the present disclosure.

FIG. 2 illustrates a side view of a depot box pedestal according to an embodiment of the present disclosure.

FIG. 3 illustrates a front view of a wall box pedestal according to an embodiment of the present disclosure.

FIG. 4 illustrates a side view of a wall box pedestal according to an embodiment of the present disclosure.

### DETAILED DESCRIPTION OF THE DISCLOSURE

It should be understood at the outset that, although exemplary embodiments are illustrated in the figures and described below, the principles of the present disclosure may be implemented using other techniques.

The present disclosure should in no way be explicitly limited to the exemplary implementations and techniques illustrated in the drawings and described below. Additionally, unless otherwise specifically noted, articles depicted in the drawings are not necessarily drawn to scale.

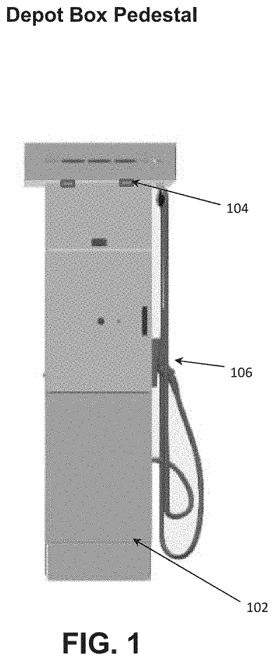

Referring now to the figures in more detail, FIG. 1 illustrates a front view of a depot box pedestal according to an embodiment of the present disclosure. It can be appreciated that the depot box pedestal greatly simplifies the process of installation and utilization of electric supply equipment.

Docking area 102 proves mounting and service access. The depot box pedestal comes equipped with solar powered LED lights 104. According to an embodiment, solar powered LED lights 104 appear at the top of the depot box pedestal. Hose 106 appears on the side of the pedestal and provides an easy way to charge an electric vehicle. According to an embodiment, an integral junction box is provided. The primary purpose of the integral junction box is to enclose the wiring connections and protect them from physical damage, as well as to prevent accidental contact with potentially live wires and terminals.

The following is a method of installation, according to an embodiment of the present disclosure:
1. Take an existing/new wall-mount AC or DC EVSE.
2. Mount it on “Pedestal” at docking area 102 and route cable through cable management retractor
3. Connect the electrical connections provided by an integral junction box (or wiring compartment)
4. Connect the communication cables provided by the integral junction box
5. Use the EVSE to charge a fleet EV as you would normally
6. Status LEDs supply information on charging: charging, charge completed, fault.

The following is a method of installation, according to an alternative embodiment of the present disclosure:
1. Take an existing/new wall-mount AC or DC EVSE.
2. Mount it on “Pedestal” at docking area 102 and route cable through cable management retractor
3. Provide a covered raceway to hold the wires.
4. Use the EVSE to charge a fleet EV as you would normally
5. Status LEDs supply information on charging: charging, charge completed, fault.

According to an optional embodiment of the present disclosure, an integrated lockout function is provided via a junction box to kill power to EVSE for safety purposes. The integrated disconnect (lockout) can be provided in 208/240/480 Volt configurations to provide the required lock out capability when servicing the EVSE Unit. The integrated disconnect also provides NEC required disconnect means (standard) for connected EVSE Devices.

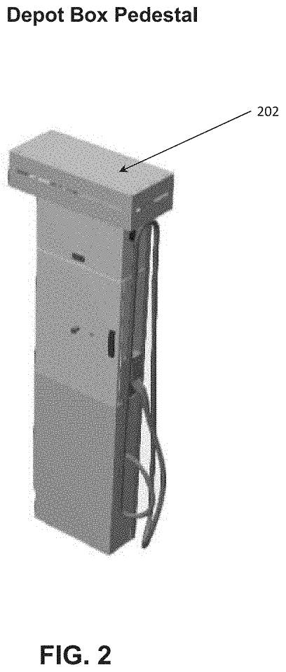

FIG. 2 illustrates a side view of a depot box pedestal according to an embodiment of the present disclosure. Convenience lighting energized by solar panel 202 can provide both nighttime functionality and safety.

According to an embodiment, solar panel 202 provides lighting/battery backup for the pedestal circuit. According to an embodiment, solar panel 202 powers LED lights 104.

According to an embodiment, aerospace-grade aluminum is employed for the pedestal frame. It can be appreciated that this provides for all weather/all climate durability with corrosion resistance.

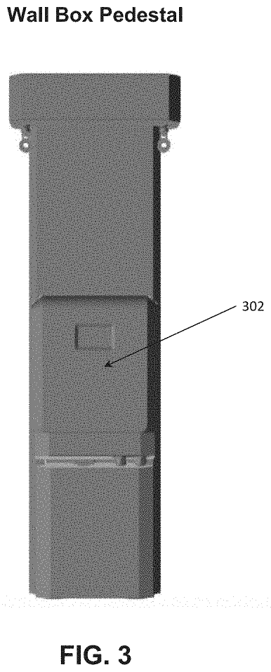

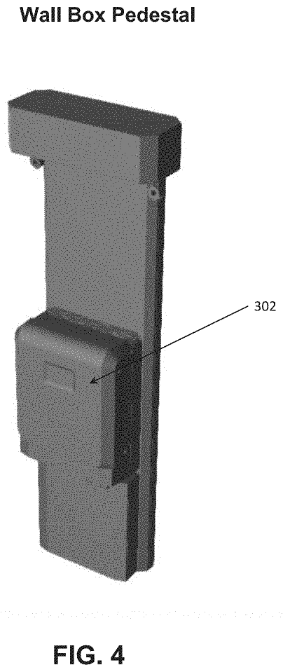

FIG. 3 illustrates a front view of a wall box pedestal according to an embodiment of the present disclosure. FIG. 4 illustrates a perspective view of a wall box pedestal according to an embodiment of the present disclosure. As show in FIGS. 3 and 4, a DC wallbox 302 has been installed in the docking area.

It can be appreciated that by using the pedestal devices disclosed herein, cables will not be left on the ground, saving valuable equipment from freezing on the ground, overheating on summer pavement and crushing due to drive-overs by fleet operators.

Modifications, additions, or omissions may be made to the systems, apparatuses, and/or methods described herein without departing from the scope of the disclosure. For example, various components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Various features and advantages of the invention are set forth in the following claims.

1. A method, comprising:
providing a pedestal device with a docking area for a wall-mount AC or DC EVSE to be docked in the pedestal device;
mounting a wall-mount box on the pedestal device at the docking area and routing a cable through a cable management retractor;
connecting electrical connections provided by an integral junction box;
connecting communication cables provided by the integral junction box; and
using the EVSE to charge a fleet EV;

2. The method of claim 1, wherein status LEDs supply information on charging.

3. The method of claim 1, wherein a frame of the pedestal device is made of aluminum.

4. The method of claim 1, wherein an integrated lockout function is provided via the integral junction box to kill power to EVSE for safety purposes

5. A pedestal device, comprising:
a docking area configured to provide mounting and service access for a wall-mount AC or DC EVSE to be docked in the pedestal device;
a mounting area for a wall-mount box on the pedestal device at the docking area;
a cable management retractor;
solar powered LED lights; and
a hose configured to charge an electric vehicle.

6. The pedestal device of claim 5, wherein solar powered LED lights appear at the top of the depot box pedestal.

7. The pedestal device of claim 5, wherein an integrated lockout function is provided via junction box to kill power to EVSE for safety purposes.
